(19) United States
(12) Patent Application Publication
(10) Pub. No.: US 2009/0175605 A1
(43) Pub. Date: Jul. 9, 2009

(54) HEAT TREATMENT APPARATUS FOR HEATING SUBSTRATE BY EXPOSING SUBSTRATE TO FLASH LIGHT

(76) Inventor: Ippei KOBAYASHI, Kyoto (JP)

Correspondence Address: OSTROLENK FABER GERB & SOFFEN, 1180 AVENUE OF THE AMERICAS, NEW YORK, NY, 100368403, US

(21) Appl. No.: 12/343,771

(22) Filed: Dec. 24, 2008

(30) Foreign Application Priority Data
Jan. 9, 2008 (JP) 2008-002015

(51) Int. Cl. A21B 2/00

(52) U.S. Cl. 392/416

(57) ABSTRACT

A semiconductor wafer to be treated is placed in a horizontal position on a holding plate held by a susceptor. Six bumps are mounted upright on the upper surface of the holding plate. The semiconductor wafer is supported by the six bumps in point contacting relationship, and is held at a distance ranging from 0.5 mm to 3 mm from the upper surface of the holding plate. Light is directed from halogen lamps onto the semiconductor wafer held by the holding plate to preheat the substrate until the temperature of the semiconductor wafer is increased up to a predetermined temperature. Thereafter, flash light is directed from flash lamps onto the semiconductor wafer. A thin gas layer lying between the back surface of the semiconductor wafer and the upper surface of the holding plate acts as a resistance to suppress the motion of the semiconductor wafer, thereby preventing a crack in the semiconductor wafer.

### BACKGROUND OF THE INVENTION

1. Field of the Invention

The present invention relates to a heat treatment apparatus for heating a substrate including a semiconductor wafer, a glass substrate and the like by exposing the substrate to flash light.

2. Description of the Background Art

Conventionally, a lamp annealer employing a halogen lamp has been typically used in the step of activating ions in a semiconductor wafer after ion implantation. Such a lamp annealer carries out the activation of ions in the semiconductor wafer by heating (or annealing) the semiconductor wafer up to a temperature of, for example, about 1000° C. to about 1100° C. Such a heat treatment apparatus utilizes the energy of light emitted from the halogen lamp to raise the temperature of a substrate at a rate of about hundreds of degrees per second.

In recent years, with the increasing degree of integration of semiconductor devices, it has been desired to provide a shallower junction as the gate length decreases. It has turned out, however, that even the execution of the process of activating ions in a semiconductor wafer by the use of the above-mentioned lamp annealer which raises the temperature of the semiconductor wafer at a rate of about hundreds of degrees per second produces a phenomenon in which the ions of boron, phosphorus and the like implanted in the semiconductor wafer are diffused deeply by heat. The occurrence of such a phenomenon causes the depth of the junction to exceed a required level, giving rise to an apprehension about a hindrance to good device formation.

To solve the problem, there has been proposed a technique for exposing the surface of a semiconductor wafer to flash light by using a xenon flash lamp to raise the temperature of only the surface of the semiconductor wafer implanted with ions in an extremely short time (several milliseconds or less). (The term “flash lamp” merely used hereinafter shall mean a “xenon flash lamp.”) The xenon flash lamp has a spectral distribution of radiation ranging from ultraviolet to near-infrared regions. The wavelength of light emitted from the xenon flash lamp is shorter than that of light emitted from the conventional halogen lamp, and approximately coincides with a basic absorption band of a silicon semiconductor wafer. It is therefore possible to rapidly raise the temperature of the semiconductor wafer, with a small amount of light transmitted through the semiconductor wafer, when the semiconductor wafer is exposed to flash light emitted from the xenon flash lamp. Also, it has turned out that flash light emitted in an extremely short time of several milliseconds or less can achieve a selective temperature rise only near the surface of the semiconductor wafer. Therefore, the temperature rise in an extremely short time by using the xenon flash lamp allows the execution of only the ion activation without deeply diffusing the ions.

A heat treatment apparatus employing such a xenon flash lamp, which momentarily exposes the semiconductor wafer to light having ultrahigh energy, rapidly raises the surface temperature of the semiconductor wafer for a very short period of time, to cause the abrupt thermal expansion of the wafer surface, resulting in a high probability that a shatter occurs in the semiconductor wafer. To solve the problem of such a crack peculiar to the heat treatment using the xenon flash lamp, for example, U.S. Pat. No. 7,062,161 discloses a technique in which a tapered portion is formed in a peripheral portion of a wafer pocket of a susceptor for holding a semiconductor wafer.

The use of the technique as disclosed in U.S. Pat. No. 7,062,161 has made it possible to prevent cracks in semiconductor wafers to a certain extent when the xenon flash lamp is used. The cracks, however, still occur with considerable frequency, depending on the types of semiconductor wafers and heat treatment conditions (preheating temperature, energy of light for exposure, and the like).

### SUMMARY OF THE INVENTION

The present invention is intended for a heat treatment apparatus for heating a substrate by exposing the substrate to flash light.

According to one aspect of the present invention, the heat treatment apparatus comprises: a chamber for receiving a substrate therein; a holding member having a plane size greater than that of the substrate and for placing and holding the substrate thereon within the chamber; a plurality of support pins mounted upright on the holding member and for supporting the substrate in point contacting relationship in such a manner that the substrate is held over and in proximity to the holding member; a flash lamp for directing flash light onto the substrate held by the holding member; and a light emitting element for directing light onto the substrate held by the holding member to preheat the substrate.

The plurality of support pins support the substrate in point contacting relationship in such a manner that the substrate is held over and in proximity to the holding member. Thus, a thin gas layer is formed between the substrate and the holding member. The air layer suppresses the violent motion of the substrate when the substrate is exposed to the flash light. This prevents a crack in the substrate when the substrate is exposed to the flash light from the flash lamp.

Preferably, at least a region of an upper surface of the holding member which is opposed to the substrate supported by the plurality of support pins is a planar surface, and a distance between the substrate supported by the plurality of support pins and the planar surface is in the range of 0.5 mm to 3 mm.

The substrate is supported at a distance ranging from 0.5 mm to 3 mm from the planar surface of the holding member. Thus, the thin gas layer is formed between the substrate and the holding member with reliability, and the substrate is prevented from colliding against the holding member if the substrate moves slightly. This prevents a crack in the substrate when the substrate is exposed to the flash light with higher reliability.

Preferably, the plurality of support pins include at least six support pins.

This causes little bending of the substrate between the support pins to prevent the decrease in temperature of the bent portions due to the approach of the bent portions to the holding member, thereby improving the uniformity of the in-plane temperature distribution within the substrate.

Preferably, the substrate supported by the plurality of support pins has a disc-shaped configuration, and the plurality of support pins are provided at positions closer to the edge of the substrate than a device formation region of the substrate.

This suppresses changes in the temperature of the device formation region due to the contact with the support pins to prevent the treatment failure of the device formation region.

It is therefore an object of the present invention to prevent a crack in a substrate when the substrate is exposed to flash light from a flash lamp.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a side sectional view showing the construction of a heat treatment apparatus according to the present invention;

FIG. 2 is a perspective view of a holding part;

FIG. 3 is a plan view of a holding plate;

FIG. 4 is an enlarged view of a bump and its vicinities when a semiconductor wafer is placed on the holding plate;

FIG. 5 is a view showing the operation of a transfer mechanism;

FIG. 6 is a view showing the holding plate holding a semiconductor wafer; and

FIG. 7 is a flow diagram showing a procedure for treatment of a semiconductor wafer in the heat treatment apparatus of FIG. 1.

### DESCRIPTION OF THE PREFERRED EMBODIMENTS

A preferred embodiment according to the present invention will now be described in detail with reference to the drawings.

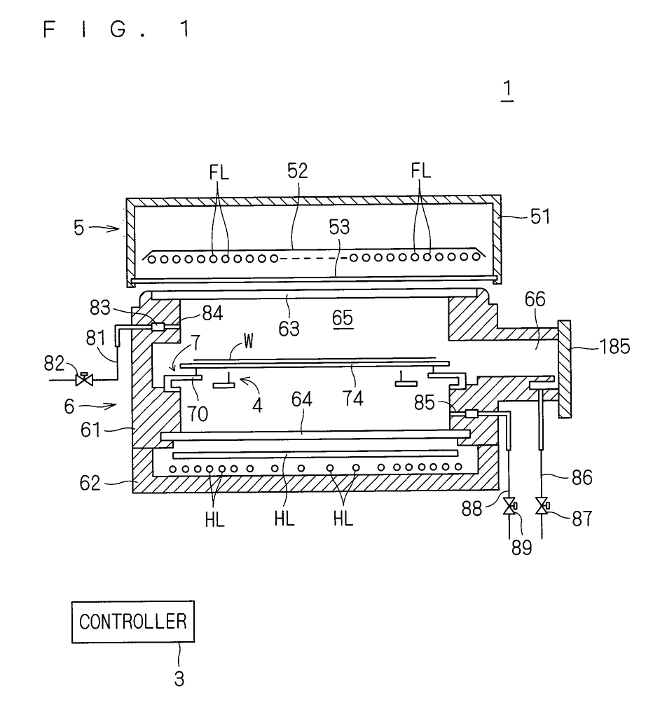

First, the overall construction of a heat treatment apparatus according to the present invention will be outlined. FIG. 1 is a side sectional view showing the construction of a heat treatment apparatus 1 according to the present invention. The heat treatment apparatus 1 according to the preferred embodiment of the present invention is a flash lamp annealer for exposing a disc-shaped semiconductor wafer W having a diameter of 300 mm and serving as a substrate to flash light to heat the semiconductor wafer W.

The heat treatment apparatus 1 includes a chamber 6 for receiving a semiconductor wafer W therein, and a lamp house 5 containing a plurality of flash lamps FL. The heat treatment apparatus 1 further includes a controller 3 for controlling operating mechanisms provided in the chamber 6 and the lamp house 5 to cause the operating mechanisms to heat-treat the semiconductor wafer W.

The chamber 6 includes an upper chamber 61 provided under the lamp house 5 and having an inner wall of a substantially cylindrical configuration, and a lower chamber 62 containing a plurality of halogen lamps HL. An upper chamber window 63 is mounted in a ceiling portion of the upper chamber 61 so that the upper portion thereof is closed. A lower chamber window 64 is mounted in a floor portion of the upper chamber 61 so that the lower portion thereof is closed. The lower chamber window 64 also functions as an atmosphere barrier wall for separation between the upper chamber 61 and the lower chamber 62. A space surrounded by the inner side wall of the upper chamber 61, the upper chamber window 63 and the lower chamber window 64 is defined as a heat treatment space 65.

The upper chamber window 63 forming the ceiling portion of the entire chamber 6 is a disc-shaped member made of quartz, and functions as a quartz window for allowing light emitted from the lamp house 5 to travel therethrough into the heat treatment space 65. The lower chamber window 64 is also a disc-shaped member made of quartz, and functions as a quartz window for allowing light from the lower chamber 62 to travel therethrough into the heat treatment space 65. A side wall portion of the upper chamber 61 is made of a metal material having high strength and high heat resistance such as, for example, stainless steel and the like. Portions of the side wall of the upper chamber 61 which lie over and under the semiconductor wafer W (or portions thereof except recesses on opposite sides of the semiconductor wafer W as viewed in FIG. 1) have an inner wall surface plated with nickel to provide an increased reflectivity.

The side wall portion of the upper chamber 61 is provided with a transport opening 66 for the transport of the semiconductor wafer W therethrough into and out of the heat treatment apparatus 1. The transport opening 66 is openable and closable by a gate valve 185. With the transport opening 66 maintained open by the gate valve 185, the semiconductor wafer W is transported through the transport opening 66 into and out of the heat treatment apparatus 1. When the transport opening 66 is closed by the gate valve 185, the heat treatment space 65 in the upper chamber 61 is an enclosed space.

A gas supply opening 84 for supplying a treatment gas (for example, an inert gas including nitrogen (N₂) gas, helium (He) gas, argon (Ar) gas and the like, or oxygen (O₂) gas and the like) therethrough into the heat treatment space 65 is formed on the opposite side of the side wall portion of the upper chamber 61 from the transport opening 66. The gas supply opening 84 is formed in the inner surface of the side wall of the upper chamber 61 above the semiconductor wafer W. The gas supply opening 84 is openly connected with an inlet passage 81 through a gas inlet buffer 83 formed inside the side wall of the upper chamber 61. The inlet passage 81 has a proximal end connected to a gas supply mechanism not shown. A gas supply valve 82 is interposed in the inlet passage 81. The treatment gas fed from the gas supply mechanism through the inlet passage 81 by opening the gas supply valve 82 flows into the gas inlet buffer 83 functioning as a buffer space, and is then fed through the gas supply opening 84 into the heat treatment space 65.

On the other hand, a gas exhaust opening 85 for exhausting the gas from the heat treatment space 65 is formed on the opposite side of the side wall portion of the upper chamber 61 from the gas supply opening 84. The gas exhaust opening 85 is formed in the inner surface of the side wall of the upper chamber 61 below the semiconductor wafer W. The gas exhaust opening 85 is openly connected with an outlet passage 88. The outlet passage 88 is connected to an exhaust mechanism not shown through an exhaust valve 89. An outlet passage 86 for exhausting the gas from the heat treatment space 65 is also connected to a distal end of the transport opening 66. The outlet passage 86 is connected to the exhaust mechanism not shown through an exhaust valve 87. By opening the gas supply valve 82 and opening the exhaust valves 87 and 89, the treatment gas supplied through the gas supply opening 84 forms a gas flow directed from the left to the right as viewed in FIG. 1 within the heat treatment space 65.

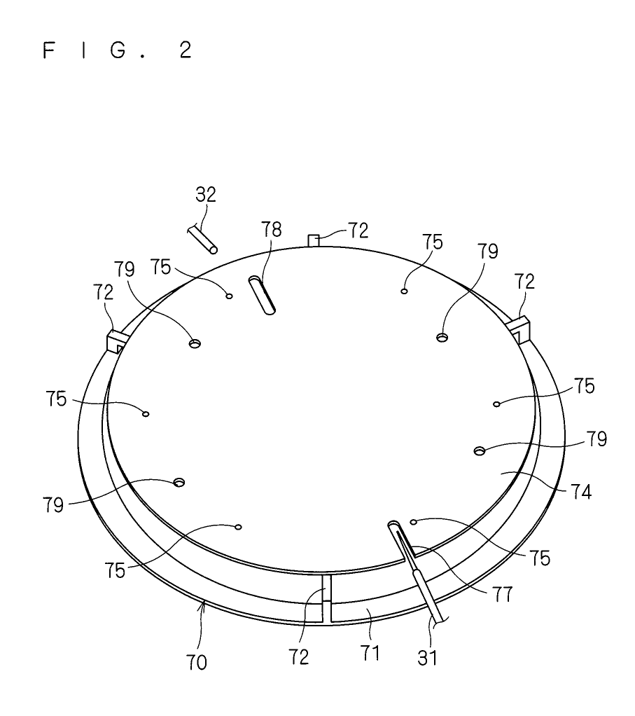

The heat treatment apparatus 1 further includes a holding part 7 for holding the semiconductor wafer W within the upper chamber 61, and a transfer mechanism 4 for transferring the semiconductor wafer W between the holding part 7 and the outside of the heat treatment apparatus 1. FIG. 2 is a perspective view of the holding part 7. The holding part 7 includes a susceptor 70 and a holding plate 74. The susceptor 70 is made of quartz, and includes a ring part 71 of an annular configuration and a plurality of lugs 72 (in this preferred embodiment, four lugs) mounted upright on the ring part 71.

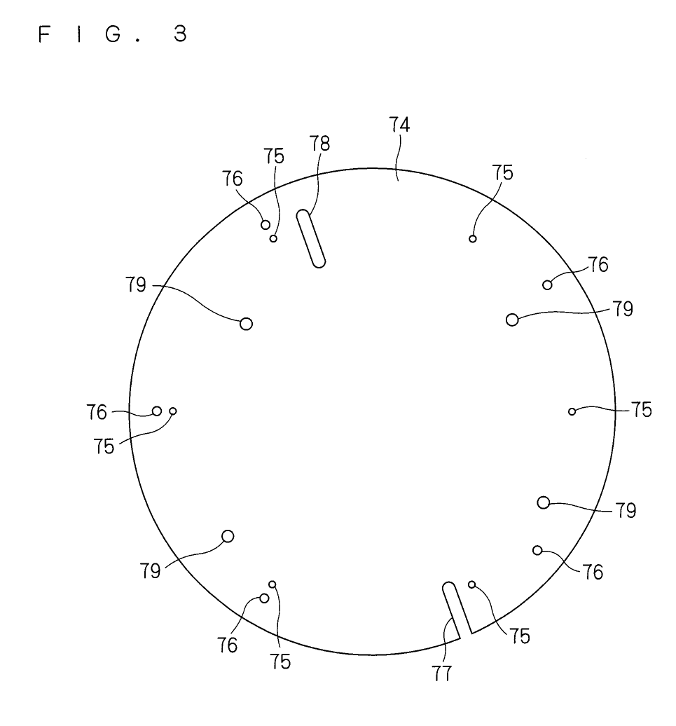

FIG. 3 is a plan view of the holding plate 74. The holding plate 74 is a circular planar member made of quartz. The diameter of the holding plate 74 is greater than that of the semiconductor wafer W. In other words, the holding plate 74 has a size in plan configuration (plane size) greater than that of the semiconductor wafer W. A plurality of bumps 75 are mounted upright on the upper surface of the holding plate 74. In this preferred embodiment, six bumps 75 spaced at intervals of 60 degrees are provided along the circumference of a circle concentric with the outer circumference of the holding plate 74. The diameter of the circle on which the six bumps 75 are spaced (a distance between circumferentially opposed ones of the bumps 75) is less than the diameter of the semiconductor wafer W, and is 280 mm in this preferred embodiment. Each of the bumps 75 is a support pin made of quartz.

A plurality of (in this preferred embodiment, five) guide pins 76 are mounted upright on the upper surface of the holding plate 74 concentrically with the six bumps 75. The diameter of a circle on which the five guide pins 76 are spaced is slightly greater than the diameter of the semiconductor wafer W. The guide pins 76 are made of quartz. In place of the plurality of guide pins 76, an annular member having a tapered surface which forms a predetermined angle with a horizontal plane so as to flare upwardly may be provided.

The ring part 71 is placed on an annular ledge formed on the side wall portion of the upper chamber 61, whereby the susceptor 70 is mounted to the upper chamber 61. The holding plate 74 is placed on the lugs 72 of the susceptor 70 mounted to the upper chamber 61. The semiconductor wafer W transported into the upper chamber 61 is placed in a horizontal position on the holding plate 74 held by the susceptor 70.

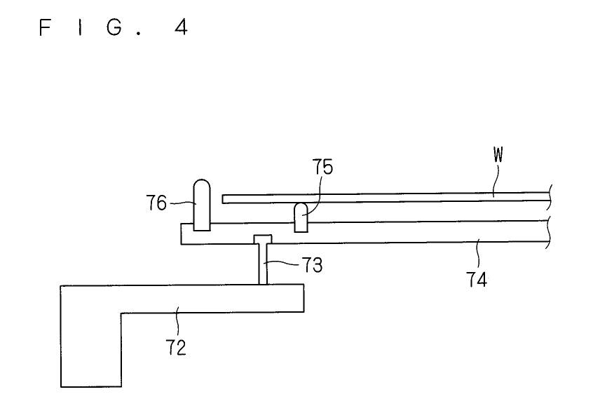

FIG. 4 is an enlarged view of one of the bumps 75 and its vicinities when the semiconductor wafer W is placed on the holding plate 74. A support rod 73 is mounted upright on each of the lugs 72 of the susceptor 70. An upper end portion of the support rod 73 is fitted in a recessed portion formed in the lower surface of the holding plate 74, whereby the holding plate 74 is held by the susceptor 70 without misregistration.

Each of the bumps 75 and the guide pins 76 is fitted in a recessed portion formed in the upper surface of the holding plate 74 and is mounted upright thereon. The upper end of each of the bumps 75 and the guide pins 76 mounted upright on the upper surface of the holding plate 74 protrudes from the upper surface thereof. The semiconductor wafer W is placed on the holding plate 74 in such a manner as to be supported by the plurality of bumps 75 mounted upright on the holding plate 74 in point contacting relationship. A distance from the vertical position of the upper end of each of the bumps 75 to the upper surface of the holding plate 74 is in the range of 0.5 mm to 3 mm (in this preferred embodiment, 1 mm). Thus, the semiconductor wafer W is supported by the plurality of bumps 75 at the distance ranging from 0.5 mm to 3 mm apart from the upper surface of the holding plate 74. The vertical position of the upper end of each of the guide pins 76 is higher than the vertical position of the upper end of each of the bumps 75. The plurality of guide pins 76 prevent the horizontal misregistration of the semiconductor wafer W. The bumps 75 and the guide pins 76 may be formed integrally with the holding plate 74.

When the annular member having the above-mentioned tapered surface is provided in placed of the guide pins 76, the annular member prevents the horizontal misregistration of the semiconductor wafer W. At least a region of the upper surface of the holding plate 74 which is opposed to the semiconductor wafer W supported by the plurality of bumps 75 is a planar surface. In this case, the semiconductor wafer W is supported by the plurality of bumps 75 at the distance ranging from 0.5 mm to 3 mm apart from the planar surface of the holding plate 74.

As shown in FIG. 2, a notch 77 and an opening 78 are formed in the holding plate 74. The notch 77 is provided to receive a distal end portion of a probe 31 of a contact-type thermometer using a thermocouple. Specifically, the probe 31 comes through the notch 77 into contact with the back surface of the semiconductor wafer W placed on the holding plate 74, and a separately placed detector measures the temperature of the semiconductor wafer W. The opening 78, on the other hand, is provided for a probe 32 of a radiation thermometer to receive radiation (infrared radiation) from the semiconductor wafer W. Specifically, the probe 32 receives the radiation from the back surface of the semiconductor wafer W placed on the holding plate 74 through the opening 78, and a separately placed detector measures the temperature of the semiconductor wafer W. The probe 31 of the contact-type thermometer and the probe 32 of the radiation thermometer are provided in the side wall portion of the upper chamber 61, more exactly, outside the susceptor 70.

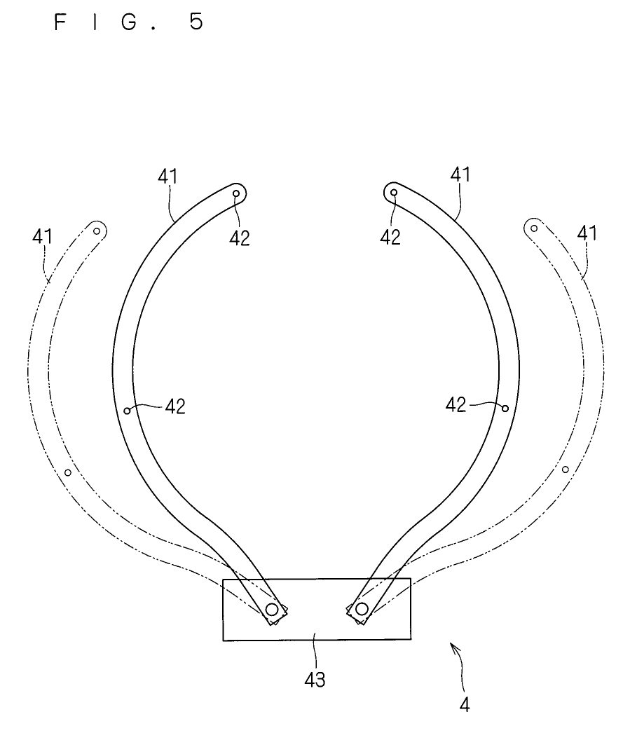

FIG. 5 is a view showing the operation of the transfer mechanism 4. The transfer mechanism 4 includes a pair of transfer arms 41. The transfer arms 41 are of an arcuate configuration extending substantially along the outer periphery of the semiconductor wafer W. A pair of lift pins 42 are mounted upright on each of the transfer arms 41. Each of the transfer arms 41 is pivotable by an opening/closing mechanism 43. The pair of transfer arms 41 are opened and closed by the opening/closing mechanism 43 between the position indicated by solid lines in FIG. 5 and the position indicated by dash-double-dot lines in FIG. 5. The pair of transfer arms 41 are moved upwardly and downwardly together with the opening/closing mechanism 43 by an elevating mechanism not shown.

As the pair of transfer arms 41 in their closed position move upwardly, the four lift pins 42 in total pass through respective four through holes 79 (with reference to FIGS. 2 and 3) formed in the holding plate 74 so that the upper ends of the lift pins 42 protrude from the upper surface of the holding plate 74. When the pair of transfer arms 41 move downwardly and are opened, on the other hand, the pair of transfer arms 41 are retracted to immediately over the ring part 71 of the susceptor 70. The retracted position of the transfer arms 41 is inside a recessed portion formed in the side wall of the upper chamber 61 (the recesses on opposite sides of the semiconductor wafer W as viewed in FIG. 1).

The plurality of halogen lamps HL are incorporated in the lower chamber 62. The plurality of halogen lamps HL direct light from a lower portion of the chamber 6 toward the heat treatment space 65. In this preferred embodiment, 20 halogen lamps HL are arranged in an upper row, and 20 halogen lamps HL are arranged in a lower row. Each of the halogen lamps HL is a rod-shaped lamp having an elongated cylindrical shape. The 20 halogen lamps HL in the upper row and the 20 halogen lamps HL in the lower row are arranged so that the longitudinal directions thereof are in parallel with each other along a main surface of the semiconductor wafer W held by the holding part 7 (that is, in a horizontal direction). Further, the halogen lamps HL in each of the upper and lower rows are disposed at a higher density in a region opposed to the peripheral portion of the semiconductor wafer W held by the holding part 7 than in a region opposed to the central portion thereof.

The halogen lamps HL in the upper row and the halogen lamps HL in the lower row are configured to intersect at right angles to each other. In other words, the 40 halogen lamps HL in total are disposed so that the longitudinal direction of the halogen lamps HL in the upper row and the longitudinal direction of the halogen lamps HL in the lower row are orthogonal to each other.

Each of the halogen lamps HL is a filament-type light source which passes current through a filament disposed in a glass tube to make the filament incandescent, thereby emitting light. A gas prepared by introducing a halogen element (iodine, bromine and the like) in trace amounts into an inert gas such as nitrogen, argon and the like is sealed in the glass tube. The introduction of the halogen element allows the temperature of the filament to be set at a high temperature while suppressing a break in the filament. Thus, the halogen lamps HL have the properties of having a longer life than typical incandescent lamps and being capable of continuously emitting intense light.

The lamp house 5 provided over the chamber 6 includes an enclosure 51, a light source having the plurality of (in this preferred embodiment, 30) xenon flash lamps FL provided within the enclosure 51, and a reflector 52 provided within the enclosure 51 to cover the upper portion of the light source. A lamp light radiation window 53 is mounted to the bottom portion of the enclosure 51 of the lamp house 5. The lamp light radiation window 53 constituting the floor portion of the lamp house 5 is a plate-like member made of quartz. The lamp house 5 is provided over the chamber 6, whereby the lamp light radiation window 53 is opposed to the upper chamber window 63. The flash lamps FL direct flash light from over the chamber 6 through the lamp light radiation window 53 and the upper chamber window 63 toward the heat treatment space 65.

The plurality of flash lamps FL each of which is a rod-shaped lamp having an elongated cylindrical shape are arranged in a plane so that the longitudinal directions of the respective flash lamps FL are in parallel with each other along the main surface of the semiconductor wafer W held by the holding part 7 (that is, in a horizontal direction). Thus, a plane defined by the arrangement of the flash lamps FL is a horizontal plane.

Each of the xenon flash lamps FL includes a glass tube (a discharge tube) containing xenon gas sealed therein and having positive and negative electrodes provided on opposite ends thereof and connected to a capacitor, and a trigger electrode wound on the outer peripheral surface of the glass tube. Because the xenon gas is electrically insulative, no current flows in the glass tube in a normal state even if electrical charge is stored in the capacitor. However, if a high voltage is applied to the trigger electrode to produce an electrical breakdown, an electrical discharge between the electrodes causes electricity stored in the capacitor to flow momentarily in the glass tube, and xenon atoms or molecules are excited at this time to cause light emission. The xenon flash lamps FL have the property of being capable of emitting much intenser light than a light source that stays lit continuously such as halogen lamps HL because previously stored electrostatic energy is converted into an ultrashort light pulse ranging from 0.1 millisecond to 10 milliseconds.

The reflector 52 is provided over the plurality of flash lamps FL to cover all of the flash lamps FL. A fundamental function of the reflector 52 is to reflect the flash light emitted from the plurality of flash lamps FL toward the holding part 7. The reflector 52 is a plate made of an aluminum alloy. The surface of the reflector 52 (which faces the flash lamps FL) is roughened by abrasive blasting to produce a stain finish thereon.

The controller 3 controls the above-mentioned various operating mechanisms provided in the heat treatment apparatus 1. The controller 3 is similar in hardware construction to a typical computer. Specifically, the controller 3 includes a CPU for performing various computation processes, a ROM or read-only memory for storing a basic program therein, a RAM or readable/writable memory for storing various pieces of information, and a magnetic disk for storing control software and data therein.

The heat treatment apparatus 1 further includes, in addition to the above-mentioned components, various cooling structures to prevent an excessive temperature rise in the chamber 6 and the lamp house 5 because of the heat energy generated from the flash lamps FL and the halogen lamps HL during the heat treatment of the semiconductor wafer W. As an example, a water cooling tube (not shown) is provided in a wall of the chamber 6. The lamp house 5 and the lower chamber 62 have an air cooling structure for forming a gas flow therein to exhaust heat. Air is supplied to a gap between the upper chamber window 63 and the lamp light radiation window 53 to cool down the lamp house 5 and the upper chamber window 63.

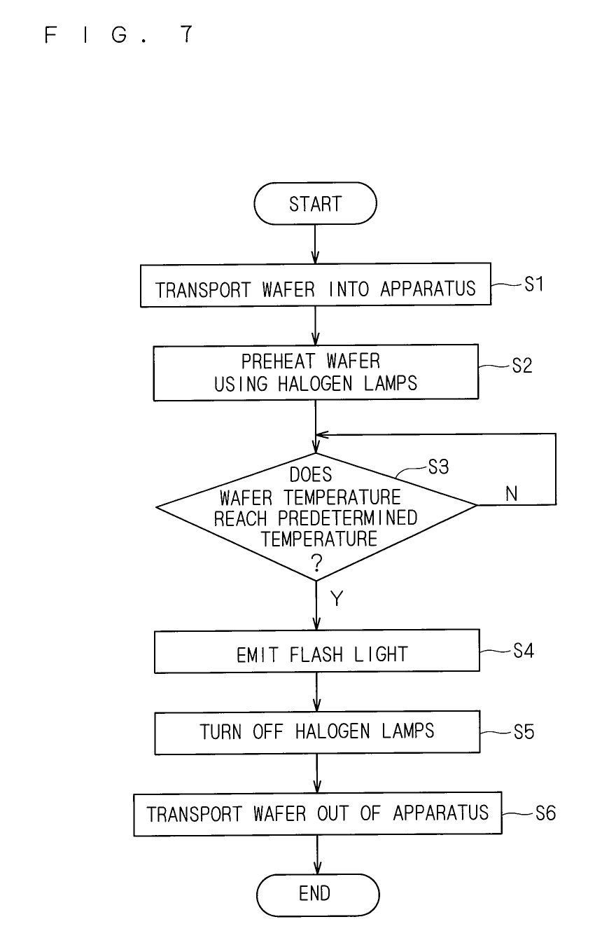

Next, a procedure for treatment of a semiconductor wafer W in the heat treatment apparatus 1 will be described briefly. The semiconductor wafer W to be treated herein is a semiconductor substrate doped with impurities (ions) by an ion implantation process. The activation of the implanted impurities is achieved by the flash heating process of the heat treatment apparatus 1. FIG. 7 is a flow diagram showing the procedure for the treatment of the semiconductor wafer W in the heat treatment apparatus 1. The procedure for the treatment of the semiconductor wafer W to be described below is executed by the controller 3 controlling the various operating mechanisms of the heat treatment apparatus 1.

Prior to the treatment, the gas supply valve 82 and the exhaust valves 87 and 89 are opened to feed nitrogen gas at room temperature into the heat treatment space 65. The fed nitrogen gas flows within the heat treatment space 65, and is exhausted through the outlet passages 86 and 88 shown in FIG. 1 by using a utility exhaust system. Subsequently, the gate valve 185 is opened to open the transport opening 66. A transport robot outside the heat treatment apparatus 1 transports the ion-implanted semiconductor wafer W through the transport opening 66 into the heat treatment space 65 within the upper chamber 61 (in Step S1). The semiconductor wafer W transported into the heat treatment space 65 by the transport robot is moved to a position lying immediately over the holding plate 74 of the holding part 7 and is stopped thereat. Then, the pair of transfer arms 41 of the transfer mechanism 4 in their closed position as indicated by the solid lines in FIG. 5 move upwardly, whereby the lift pins 42 protrude from the upper surface of the holding plate 74 to receive the semiconductor wafer W.

After the semiconductor wafer W is placed on the lift pins 42, the transport robot moves out of the heat treatment space 65, and the gate valve 185 closes the transport opening 66. Then, the pair of transfer arms 41 move downwardly to transfer the semiconductor wafer W from the transfer mechanism 4 to the holding plate 74 of the holding part 7. The pair of transfer arms 41 moved downwardly to under the holding plate 74 are opened as indicated by the dash-double-dot lines in FIG. 5 to retract into the recessed portion formed in the side wall of the upper chamber 61.

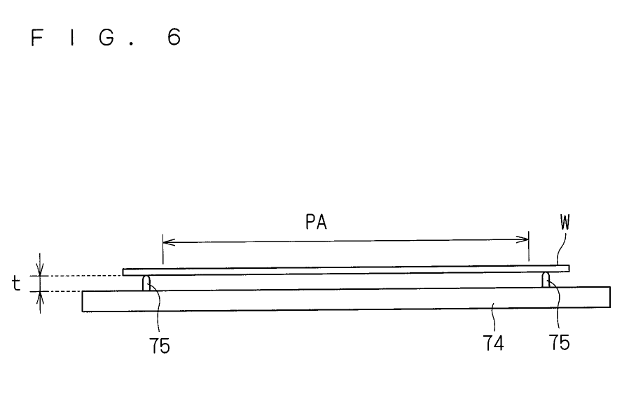

FIG. 6 is a view showing the holding plate 74 holding the semiconductor wafer W. The semiconductor wafer W is supported by the six bumps 75 in point contacting relationship, and is held at a distance t ranging from 0.5 mm to 3 mm from the upper surface of the holding plate 74. The distance t is 1 mm in this preferred embodiment. The plurality of bumps 75 support the semiconductor wafer W at positions closer to the edge of the semiconductor wafer W than a device formation region PA (in which a device is to be formed) of the semiconductor wafer W (i.e., at positions outside the device formation region PA). In other words, a device pattern is not entirely formed on the surface of the semiconductor wafer W, and is not formed near the edge thereof. The plurality of bumps 75 of the holding plate 74 come in contact with a region of the semiconductor wafer W in which such a device pattern is not formed to support the semiconductor wafer W.

After the semiconductor wafer W is placed and held on the holding plate 74 of the holding part 7, the 40 halogen lamps HL turn on to start preheating (or assist-heating) (in Step S2). Halogen light emitted from the halogen lamps HL passes through the lower chamber window 64 and the holding plate 74 both made of quartz to impinge upon the back surface of the semiconductor wafer W. The semiconductor wafer W exposed to the light from the halogen lamps HL is preheated so that the temperature thereof increases. Since the halogen lamps HL are disposed at a higher density in the region opposed to the peripheral portion of the semiconductor wafer W than in the region opposed to the central portion thereof, a greater amount of light impinges upon the peripheral portion of the semiconductor wafer W in which more heat is dissipated. The semiconductor wafer W is preheated accordingly more uniformly.

During the preheating, the temperature of the semiconductor wafer W is measured by the contact-type thermometer and the radiation thermometer. Specifically, the probe 31 of the contact-type thermometer comes through the notch 77 of the holding plate 74 into contact with the back surface of the semiconductor wafer W, and the probe 32 of the radiation thermometer receives the radiation from the back surface of the semiconductor wafer W through the opening 78. The probes 31 and 32 measure the temperature of the semiconductor wafer W from obliquely below the semiconductor wafer W so as not to obstruct the light coming from the halogen lamps HL. The susceptor 70 and the holding plate 74 which constitute the holding part 7 are all made of quartz so as not to obstruct the light directed from the halogen lamps HL onto the back surface of the semiconductor wafer W. The transfer arms 41 of the transfer mechanism 4 are retracted in the recessed portion formed in the side wall of the upper chamber 61 so as not to hinder the halogen lamps HL from preheating.

The two types of thermometers are used to monitor whether the temperature of the semiconductor wafer W reaches a predetermined preheating temperature T1 or not (in Step S3). In this preferred embodiment, the preheating temperature T1 shall be 800° C. Immediately after the temperature of the semiconductor wafer W reaching the preheating temperature T1 is detected, flash light is emitted from the flash lamps FL of the lamp house 5 toward the semiconductor wafer W (in Step S4). Part of the flash light emitted from the flash lamps FL travels directly toward the holding part 7 in the heat treatment space 65. The remainder of the flash light is reflected by the reflector 52, and the reflected light travels into the heat treatment space 65. The emission of such flash light achieves the flash heating of the semiconductor wafer W. The flash heating, which is achieved by the emission of flash light from the flash lamps FL, can raise the temperature of the front surface of the semiconductor wafer W in a short time.

Specifically, the flash light emitted from the flash lamps FL of the lamp house 5 is intense flash light emitted for an extremely short period of time ranging from about 0.1 millisecond to about 10 milliseconds because the previously stored electrostatic energy is converted into such an ultrashort light pulse. The temperature of the front surface of the semiconductor wafer W subjected to the flash heating by the emission of the flash light from the flash lamps FL momentarily rises to a treatment temperature T2 of about 1000° C. to about 1100° C. After the impurities implanted in the semiconductor wafer W are activated, the temperature of the front surface of the semiconductor wafer W decreases rapidly. Because of the capability of increasing and decreasing the temperature of the front surface of the semiconductor wafer W in an extremely short time, the heat treatment apparatus 1 can achieve the activation of the impurities while suppressing the diffusion of the impurities implanted in the semiconductor wafer W due to heat. Because the time required for the activation of the implanted impurities is extremely short as compared with the time required for the thermal diffusion of the implanted impurities, the activation is completed in a short time ranging from about 0.1 millisecond to about 10 milliseconds during which no diffusion occurs.

In the heat treatment apparatus 1 according to this preferred embodiment, the halogen lamps HL preheat the semiconductor wafer W up to the preheating temperature T1 (800° C.), and thereafter the flash lamps FL emit the flash light for flash heating. When the temperature of the semiconductor wafer W reaches 600° C. or higher, there is a likelihood that the implanted impurities are thermally diffused. However, the heat treatment apparatus 1 minimizes the thermal diffusion of the implanted impurities because the halogen lamps HL can raise the temperature of the semiconductor wafer W up to 800° C. relatively rapidly. Also, the flash light is emitted from the flash lamps FL after the temperature of the semiconductor wafer W is raised up to the preheating temperature T1. This rapidly increases the temperature of the front surface of the semiconductor wafer W up to the treatment temperature T2. Additionally, a temperature increase from the preheating temperature T1 to the treatment temperature T2 by flash heating is relatively small. This allows a relatively small amount of energy of the flash light emitted from the flash lamps FL, thereby to reduce the thermal shock to the semiconductor wafer W during the flash heating.

After a predetermined length of time has elapsed since the completion of the flash heating, the halogen lamps HL turn off so that the temperature of the semiconductor wafer W decreases rapidly (in Step S5). Thereafter, the pair of transfer arms 41 of the transfer mechanism 4 in their closed position move upwardly, whereby the lift pins 42 protrude from the upper surface of the holding plate 74 to receive the heat-treated semiconductor wafer W from the holding plate 74. Subsequently, the transport opening 66 which has been closed is opened by the gate valve 185, and the transport robot outside the heat treatment apparatus 1 transports the semiconductor wafer W placed on the lift pins 42 to the outside (in Step S6). Thus, the heat treatment apparatus 1 completes the flash heating process of the semiconductor wafer W. The nitrogen gas is continuously fed into the heat treatment space 65 during the heat treatment of the semiconductor wafer W in the heat treatment apparatus 1. The amount of nitrogen gas fed into the heat treatment space 65 is changed as appropriate in accordance with the processing steps of FIG. 7.

In the above-mentioned heat treatment steps, the temperature of the front surface of the semiconductor wafer W subjected to the flash heating by the emission of the flash light from the flash lamps FL momentarily increases to the treatment temperature T2 of about 1000° C. to about 1100° C., whereas the temperature of the back surface of the semiconductor wafer W at that moment does not increase so high from the preheating temperature T1. This causes the abrupt thermal expansion of only the front surface of the semiconductor wafer W to exert stresses which warp the semiconductor wafer W so that the upper surface thereof is convex upward on the semiconductor wafer W. In the next moment, the temperature of the front surface of the semiconductor wafer W decreases rapidly, whereas the temperature of the back surface thereof increases slightly because of the transfer of heat from the front surface to the back surface. Thus, stresses which warp the semiconductor wafer W in a direction opposite from that described above are exerted on the semiconductor wafer W. As a result, the semiconductor wafer W tends to move violently on the holding plate 74.

In this preferred embodiment, the semiconductor wafer W having a diameter of 300 mm is supported by the six bumps 75 in point contacting relationship, and is held at the distance t of 1 mm from the upper surface of the holding plate 74. This causes a thin gas layer to lie between the back surface of the semiconductor wafer W and the upper surface of the holding plate 74. Such a thin gas layer acts as a resistance against the motion of the semiconductor wafer W tending to warp. Specifically, the thin gas layer is less susceptible to change in volume because it is difficult for any gas to enter and exit the thin gas layer lying between the back surface of the semiconductor wafer W and the upper surface of the holding plate 74. This serves as the resistance against the motion of the semiconductor wafer W tending to warp. As a result, when exposed to the flash light from the flash lamps FL, the semiconductor wafer W moves very little while being supported by the six bumps 75, and is prevented from being cracked.

If the distance t from the upper surface of the holding plate 74 to the back surface of the semiconductor wafer W exceeds 3 mm, gas enters and exits the thin gas layer lying therebetween easily, and the gas layer no longer functions as the resistance against the motion of the semiconductor wafer W. As a result, when exposed to the flash light, the semiconductor wafer W moves violently on the six bumps 75, and there is an apprehension that the semiconductor wafer W collides against the upper surface of the holding plate 74 to become cracked.

If the distance t from the upper surface of the holding plate 74 to the back surface of the semiconductor wafer W is less than 0.5 mm, on the other hand, a thin gas layer is formed therebetween. However, even if the thin gas layer is formed, the semiconductor wafer W moves slightly when exposed to the flash light. When the distance t is less than 0.5 mm, there is an apprehension that only the slight motion of the semiconductor wafer W causes the semiconductor wafer W to collide against the holding plate 74, thereby resulting in a crack in the semiconductor wafer W. For these reasons, the distance t from the upper surface of the holding plate 74 to the back surface of the semiconductor wafer W shall be in the range of 0.5 mm to 3 mm in this preferred embodiment. When the annular member having the above-mentioned tapered surface is provided in placed of the guide pins 76, the distance t from the planar surface of the holding plate 74 opposed to the semiconductor wafer W to the back surface of the semiconductor wafer W is in the range of 0.5 mm to 3 mm. This also suppresses the violent motion of the semiconductor wafer W when the semiconductor wafer W is exposed to the flash light to prevent a crack in the semiconductor wafer W.

In this preferred embodiment, the plurality of bumps 75 support the semiconductor wafer W at the positions closer to the edge of the semiconductor wafer W than the device formation region PA of the semiconductor wafer W (i.e., at the positions outside the device formation region PA). Because the bumps 75 are made of quartz, the bumps 75 allow the light from the halogen lamps HL to pass therethrough, and the temperature of the bumps 75 increases very little during the preheating. Thus, portions of the semiconductor wafer W which are in contact with the bumps 75 having a relatively low temperature are considered to become lower in temperature than the remaining portions thereof. At least a treatment failure resulting from the decrease in the temperature of the device formation region PA is prevented, when the plurality of bumps 75 of the holding plate 74 are configured to come in contact with the portions of the semiconductor wafer W which are closer to the edge thereof than the device formation region PA to hold the semiconductor wafer W.

While the preferred embodiment according to the present invention has been described hereinabove, various modifications of the present invention in addition to those described above may be made without departing from the scope and spirit of the invention. For example, the six bumps 75 mounted upright on the holding plate 74 are used to support the semiconductor wafer W in the above-mentioned preferred embodiment. However, the number of bumps 75 is not limited to six, but it is necessary only that at least three bumps 75 capable of supporting the semiconductor wafer W with stability be provided.

When three bumps 75 are used to support the semiconductor wafer W, the semiconductor wafer W is slightly bent between the bumps 75 because of the smaller number of supporting points. On the other hand, the temperature of the holding plate 74 increases very little during the preheating because the holding plate 74 is made of quartz. For this reason, there is an apprehension that the bent portions of the semiconductor wafer W which lie between the bumps 75 approach the holding plate 74 to result in the decrease in temperature of the bent portions. The use of at least six bumps 75 to support the semiconductor wafer W as in the above-mentioned preferred embodiment causes little bending of the semiconductor wafer W between the bumps 75. As a result, this prevents the decrease in temperature of the bent portions to improve the uniformity of the in-plane temperature distribution within the semiconductor wafer W.

Another modification may be made such that a gently inclined tapered surface or a concave surface having a large radius of curvature is formed in the upper surface of the holding plate 74 and the plurality of bumps 75 are mounted upright on the tapered surface or the concave surface to support the semiconductor wafer W.

The holding plate 74 is made of quartz in the above-mentioned preferred embodiment, but may be made of silicon carbide (SiC). The configuration of the SiC holding plate shall be similar to that described in the above-mentioned preferred embodiment with reference to FIGS. 2 and 3. Since SiC does not allow the light emitted from the halogen lamps HL to pass therethrough, the temperature of the holding plate itself increases during the preheating, and the semiconductor wafer W is preheated by being heated by the holding plate increased in temperature. When the SiC holding plate is used, the semiconductor wafer W is also supported by the plurality of bumps in point contacting relationship and is held at a distance t ranging from 0.5 mm to 3 mm from the upper surface of the holding plate. Like the quartz holding plate 74, the SiC holding plate thus suppresses the violent motion of the semiconductor wafer W when the semiconductor wafer W is exposed to the flash light to prevent a crack in the semiconductor wafer W.

In the above-mentioned preferred embodiment, when the temperature of the semiconductor wafer W reaches the preheating temperature T1, flash light is emitted from the flash lamps FL while the halogen lamps HL remain on. Instead, after the temperature of the semiconductor wafer W is increased to exceed the preheating temperature T1 by the halogen lamps HL, the halogen lamps HL may be turned off, and flash light may be emitted when the temperature of the semiconductor wafer W decreases down to the preheating temperature T1.

Although the 30 flash lamps FL are provided in the lamp house 5 according to the above-mentioned preferred embodiment, the present invention is not limited to this. Any number of flash lamps FL may be provided. The flash lamps FL are not limited to the xenon flash lamps, but may be krypton flash lamps. The number of halogen lamps HL is not limited to 40, but any number of halogen lamps HL may be provided.

The heat source for preheating is not limited to the halogen lamps HL. The preheating may be performed by placing the semiconductor wafer W on a hot plate incorporating a heater such as a resistance heating element and the like. In this case, a holding plate similar to that described in the above-mentioned preferred embodiment is placed on the hot plate, and holds the semiconductor wafer W at a distance ranging from 0.5 mm to 3 mm. This also suppresses the violent motion of the semiconductor wafer W when the semiconductor wafer W is exposed to the flash light to prevent a crack in the semiconductor wafer W.

In the above-mentioned preferred embodiment, the ion activation process is performed by exposing the semiconductor wafer to light. The substrate to be treated by the heat treatment apparatus according to the present invention is not limited to the semiconductor wafer. For example, the heat treatment apparatus according to the present invention may treat a glass substrate formed with various silicon films including a silicon nitride film, a polycrystalline silicon film and the like. As an example, silicon ions are implanted into a polycrystalline silicon film formed on a glass substrate by a CVD process to form an amorphous silicon film, and a silicon oxide film serving as an anti-reflection film is formed on the amorphous silicon film. In this state, the heat treatment apparatus according to the present invention may expose the entire surface of the amorphous silicon film to light to polycrystallize the amorphous silicon film, thereby forming a polycrystalline silicon film.

Another modification may be made in a manner to be described below. A TFT substrate is prepared such that an underlying silicon oxide film and a polysilicon film produced by crystallizing amorphous silicon are formed on a glass substrate and the polysilicon film is doped with impurities such as phosphorus or boron. The heat treatment apparatus according to the present invention may expose the TFT substrate to light to activate the impurities implanted in the doping step.

While the invention has been described in detail, the foregoing description is in all aspects illustrative and not restrictive. It is understood that numerous other modifications and variations can be devised without departing from the scope of the invention.

What is claimed is:

1. A heat treatment apparatus for heating a substrate by exposing the substrate to flash light, comprising:
a chamber for receiving a substrate therein;
a holding member having a plane size greater than that of the substrate and for placing and holding the substrate thereon within said chamber;
a plurality of support pins mounted upright on said holding member and for supporting the substrate in point contacting relationship in such a manner that the substrate is held over and in proximity to said holding member;
a flash lamp for directing flash light onto the substrate held by said holding member; and
a light emitting element for directing light onto the substrate held by said holding member to preheat the substrate.

2. The heat treatment apparatus according to claim 1, wherein
at least a region of an upper surface of said holding member which is opposed to the substrate supported by said plurality of support pins is a planar surface, and
a distance between the substrate supported by said plurality of support pins and said planar surface is in the range of 0.5 mm to 3 mm.

3. The heat treatment apparatus according to claim 1, wherein
said plurality of support pins include at least six support pins.

4. The heat treatment apparatus according to claim 1, wherein:
said holding member is made of quartz;
said light emitting element is provided under said chamber; and
said flash lamp is provided over said chamber.

5. The heat treatment apparatus according to claim 4, wherein
the substrate supported by said plurality of support pins has a disc-shaped configuration, and
said plurality of support pins are provided at positions closer to the edge of the substrate than a device formation region of the substrate.

6. The heat treatment apparatus according to claim 1, wherein:
said holding member is made of silicon carbide;
said light emitting element is provided under said chamber; and
said flash lamp is provided over said chamber.

7. The heat treatment apparatus according to claim 1, wherein
said light emitting element includes a halogen lamp.

8. The heat treatment apparatus according to claim 1, further comprising
a probe for measuring the temperature of the substrate held by said holding member,
wherein an opening through which said probe measures the temperature of the substrate is formed in said holding member.

9. The heat treatment apparatus according to claim 1, further comprising
a plurality of guide pins mounted upright on said holding member and for preventing the horizontal misregistration of the substrate.
